(19) United States
(12) Patent Application Publication
(10) Pub. No.: US 2007/0220059 A1
(43) Pub. Date: Sep. 20, 2007

(54) Data processing node

(76) Inventors: Manyi Lu, Trondheim (NO); Rune Humborstad, Trondheim (NO); Olav Sandsta, Trondheim (NO); Dyre Tjeldvoll, Trondheim (NO); Sverre Hendseth, Trondheim (NO); Svein Erik Bratsberg, Trondheim (NO); Svein-Olaf Hvasshovd, Trondheim (NO); Vemund Ostgaard, Trondheim (NO)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/385,409

(22) Filed: Mar. 20, 2006

(51) Int. Cl. G06F 17/30

(52) U.S. Cl. 707/200

(57) ABSTRACT

A high availability database can be provided having a plurality of interconnected nodes. Each node can having a processing engine, volatile memory and non-volatile memory. The database can be configured: at a participant node of a transaction performed within the database, to create a record of the transaction; to record a current status of the transaction by storing the record in volatile memory; and to record a long term record of the transaction by storing the record in non-volatile memory. In one example, nodes can be organized into neighbor groups, where each node in the neighbor group maintains a copy of the same data fragments and receives a copy of log records from a primary member of the group.

### INTRODUCTION

The present invention relates to a data processing node and a transaction log storage manager for a data processing node. In particular, but not exclusively, the present invention relates to distributed secondary logging in a continuously available database management system.

### BACKGROUND

High availability databases are required for a number of applications, for example mobility management for a cellular telephony system and intelligent networks. The properties of a high availability database should match the properties for the components of the system in which the high availability database resides, for example a telephony network. In order to operate within such conditions, a high availability database has to be highly fault-tolerant and operate “self-healing” systems which use automated replication mechanisms to achieve sub-second masking of failures and unattended self-repair.

Features often seen as desirable in a high availability database include high availability and real time operation. Many database users require Class 5 availability, that is 99.999% availability. In real terms, this equates to a down-time of less than five minutes per year. Providing Class 5 availability requires that the system masks both hardware and software failures such that continuous uninterrupted operation of the database occurs in the event of such a failure. Also, it must be possible to perform all maintenance tasks online, that is, all hardware scaling and software upgrades must be possible to be performed transparently to users of the database.

Real time operation means that as external events which trigger transactions occur, those transactions are logged. In real terms this requires a transaction which updates four records within the database to execute in less than one millisecond. Real time operation is of particular importance in telecommunications fields, for example a database used for storing location information of mobile telephones within a cellular telephone network. Other features which may be advantageous for a high availability database include an ability to be implemented using standard hardware and software, and a standard data format compatibility, for example SQL or dBase.

The present invention was devised in consideration of the drawbacks of conventional systems.

### SUMMARY

Viewed from a first aspect, the present invention provides a high availability database. The database can have a plurality of interconnected nodes. Each node can have a processing engine, volatile memory and non-volatile memory. The database can be configured to create a log record of a transaction operation performed within the database at a participant node of the transaction operation. The database can also be configured to record a current status of the transaction by storing the log record in volatile memory; and to record a long term log record of the transaction by storing the record in non-volatile memory. This arrangement provides resiliency to failures by maintaining a record of ongoing transaction operations in non-volatile storage.

In one embodiment, the database can be configured to overwrite the log record stored in volatile memory following completion of the transaction. Thereby, limited volatile storage may be provided within each node as only log records from active transactions are kept in the non-volatile storage.

In one embodiment, the database can be further configured to overwrite the log record stored in volatile memory following the expiry of a predetermined time period. Thereby, limited volatile storage may be provided within each node as only recent records are maintained in the volatile storage.

In one embodiment the database can be further configured to migrate the log record stored in non-volatile memory from a first non-volatile memory to a second non-volatile memory following the expiry of a predetermined time period. The first non-volatile memory can be a primary working memory or a hard disk drive of the node, and the second non-volatile memory can be an archive hard disk drive. Thereby, a long term record of all log entries can be kept, without burdening the individual nodes with a need to maintain large logs in large non-volatile storage areas.

In one embodiment, the database can be further configured to migrate the log record stored in non-volatile memory to a third non-volatile memory in addition to the second non-volatile memory if a transaction to which the log record relates is not completed before the expiry of a predetermined time period. The log record can be deleted from the third non-volatile memory following completion of the transaction to which the log record relates. The first non-volatile memory can be a hard disk drive of the node, the second non-volatile memory can be an archive hard disk drive, and the third non-volatile memory can be a hard disk drive of the node. Thus records relating to transaction operations of long duration can be kept locally to the node without interrupting the normal operation of the storing of log records to non-volatile storage.

In one embodiment, the database can be further configured to store the log record to volatile memory independently of storing the log record to non-volatile memory. Storing the log record to non-volatile memory can also be independent of a transaction completion phase of the transaction to which the log record relates. Thus conduct of transaction operations can continue unhindered by any delay in writing the records to the non-volatile storage.

In one embodiment, the log record can be stored to non-volatile memory in response to fill level of a log buffer of the node, and/or following the expiry of a predetermined time limit. This arrangement allows management of writing the records to non-volatile storage to take place in a controlled manner avoiding excessive management overheads for the write operation by writing several records to non-volatile storage at one time.

In one embodiment, each node can be configured into a paired node arrangement with a second node of the database in respect of each data element stored at the node. Each node of a node pair can be configured to receive a log record from the other node of the node pair and to store the received log record in at least one of said volatile memory and said non-volatile memory as a mirror log for the other node. Each node of the node pair can be configured to transmit a copy of each log record to the other node of the pair for storage in a mirror log at the other node. Thus a data mirroring system can be implemented for increased durability and database availability.

A computer program product can be provided embodied on a computer-readable medium and comprising processor implementable instructions for causing a programmable processing apparatus to become configured as the database as set out above. The carrier medium can comprises at least one of a magnetic disc, an optical disc, a solid-state storage device and a signal. Thus a general purpose computer system can be configured to carry out the tasks of the database system.

Viewed from a second aspect, the invention provides a method of operating a high availability database having a plurality of interconnected nodes. Each node can have a processing engine, volatile memory and non-volatile memory. The method can comprise creating, at a participant node of a transaction performed within the database, a log record of the transaction. The method can also comprise storing the log record in volatile memory for recording a current status of the transaction, and storing the log record in non-volatile memory for recording a long term record of the transaction. This method provides resiliency to failures by maintaining a record of ongoing transaction operations in non-volatile storage.

Viewed from another aspect, the invention can provide a log storage manager for a data processing node of a data processing node pair of a high availability database. The log storage manager can be operable to create, at the node, a log record of a transaction for which the node is a participant node. The log storage manager can be further operable to store the log record in volatile memory to record a current status of the transaction, and to store the log record in non-volatile memory to record a long term record of the transaction. This arrangement provides resiliency to failures by maintaining a record of ongoing transaction operations in non-volatile storage.

Viewed from another aspect, the invention provides a method of operating a data processing node for a high availability database. The method can comprise storing a local log of one or more transactions performed by said data processing node in said data processing node main memory, and storing a copy of said local log in persistent data storage. This method provides resiliency to failures by maintaining a record of ongoing transaction operations in non-volatile storage.

Viewed from another aspect, the present invention provides a data processing node for a high availability database. The node can comprise means for storing a local log of one or more transactions performed by said data processing node in main memory means of said data processing node; and means for storing a copy of said local log in persistent data storage means of said data processing node. This arrangement provides resiliency to failures by maintaining a record of ongoing transaction operations in non-volatile storage.

Viewed from another aspect, the present invention provides a data processing node for a high availability database. The node can comprise a log save manager operable to cause a local log of one or more transactions performed by said data processing node to be stored in a main memory of said data processing node, and a log disk manager operable to cause a copy of said local log to be stored in persistent data storage. This arrangement provides resiliency to failures by maintaining a record of ongoing transaction operations in non-volatile storage.

In one embodiment, the node can be a node of a data processing node pair for a high availability database. The node can be operable to store the local log as part of a commit phase for a corresponding transaction in the other data processing node of said data processing node pair, responsive to a failure of said other data processing node of said data processing node pair. Thus a mirroring arrangement can be provided for greater data durability and database availability.

Viewed from another aspect, the invention can provide a method of operating a distributed data processing system for a high availability database. The database can comprise a first (primary) data processing node and a second (mirror) data processing node, each node comprising: a log save manager operable to cause a local log of one or more transactions performed by said data processing node to be stored in a main memory of said data processing node; and a log disk manager operable to cause a copy of said local log to be stored in persistent data storage. The method can comprise communicating from said first data processing node a first node log to said second data processing node, and said second data processing node storing said first node log record in node memory to form a mirror log for said first data processing node. This arrangement provides resiliency to failures by maintaining a record of ongoing transaction operations in non-volatile storage.

Viewed from another aspect, the present invention provides, a log storage manager for a data processing node of a high availability database. The log storage manager can be operable to store a local log of one or more transactions performed by said data processing node in a node memory associated with said data processing node, and initiate storing a copy of said local log in a persistent data storage. This arrangement provides resiliency to failures by maintaining a record of ongoing transaction operations in non-volatile storage

Viewed from another aspect, the present invention provides a data processing node for a high availability database. The node can comprise a log storage manager operable to store a local log of one or more transactions performed by said data processing node in a node memory associated with said data processing node, and to initiate storing a copy of said local log in a persistent data storage. The node can further comprise a processing resource for implementing said log storage manager, a node main memory for storing said local log of one or more transactions, and persistent data storage. This arrangement provides resiliency to failures by maintaining a record of ongoing transaction operations in non-volatile storage

Viewed from another aspect, the present invention provides a distributed data processing system for a high availability database. The database can comprise a first (primary) data processing node and a second (mirror) data processing node, each node comprising: a log storage manager operable to store a local log of one or more transactions performed by said data processing node in a node memory associated with said data processing node, and to initiate storing a copy of said local log in a persistent data storage; a processing resource for implementing said log storage manager; a node main memory for storing said local log of one or more transactions; and persistent data storage. In the system the log storage manager of said first data processing node can be operable to communicate a copy of a local log to said second data processing node for storing in node memory of said second data processing node to form a mirror log for said first data processing node, and the log storage manager of said second data processing node can be operable to initiate storing a copy of said mirror log in persistent data storage. This arrangement provides resiliency to failures by maintaining a record of ongoing transaction operations in a mirror node.

### BRIEF DESCRIPTION OF THE FIGURES

Particular embodiments of the present invention will now be described, by way of example only, with reference to the accompanying drawings in which like parts are identified by like reference numerals:

FIG. 1 shows a schematic representation of a server cluster for a high availability database;

FIG. 2 shows a schematic representation of a computer system suitable for use as a node within the cluster of FIG. 1;

FIGS. 3a and 3b show a schematic representation of a scheme for distribution of records about a high availability database;

FIG. 4 shows a schematic representation of database software services executed by each node;

FIGS. 5a to 5e show a schematic representation of messages passed between nodes of a high availability database during a write operation;

FIG. 6 shows steps performed within a high availability database during a write operation;

FIG. 7a shows a schematic representation of a transaction table for recording details of a transaction within a high availability database;

FIG. 7b shows a schematic representation of a transaction object for the transaction table of FIG. 7a;

FIG. 8 shows a schematic representation of a logical architecture for storing transaction logs to disk;

FIG. 9 shows a schematic representation of the logical arrangement of a transaction log;

FIG. 10 shows a schematic representation of transaction log files within a transaction log;

FIG. 11 shows a schematic representation of kernel threads associated with storing a transaction log to disk;

FIG. 12 shows a schematic representation of dual node failure scenarios;

FIG. 13 shows a schematic representation of a recovery following dual node failure scenario; and

FIG. 14 shows a schematic representation of a recovery following dual node failure scenario.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

Database Architecture

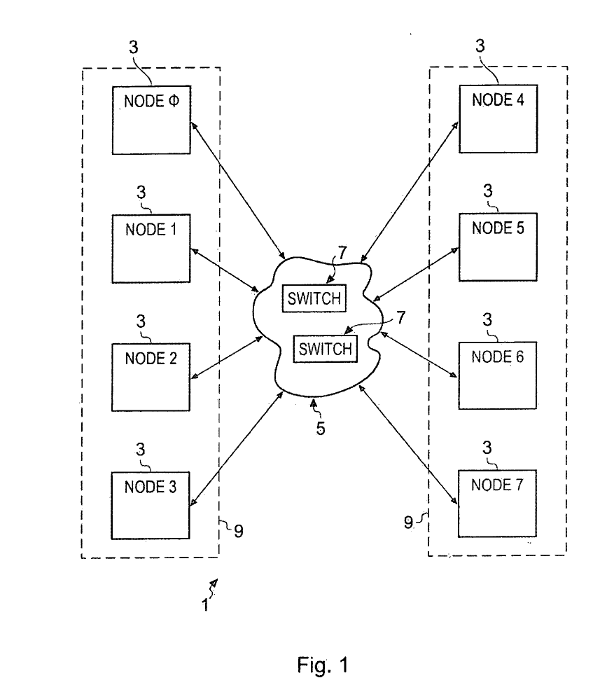

FIG. 1 shows a schematic and simplified representation of the architecture of a server cluster for a database such as a high availability database. A number of nodes 3 are interconnected via a network 5, and communicate via a suitable network communications protocol. Communication may be via low-overhead protocol such as the User Datagram Protocol (UDP) operating on top of and independently of an underlying network environment, which may be Ethernet, InfiniBand™, Fibre Distributed Data Infrastructure (FDDI) or Asynchronous Transfer Mode (ATM) for example. The switch fabric 5 of the present example includes two switches 7 such that each node can be connected to each of the switches to provide a dual redundant system.

The architecture illustrated in FIG. 1 is of a single database site comprising two groups 9. In the system of the present example, each group includes 4 substantially identical nodes 3. As will become apparent, the total number of nodes is not relevant to the operation of the system, although an equal number of nodes in each group can provide optimum performance. Additionally, the nodes can be divided into more than two groups.

Each node 3 of the present example is an individual data processing apparatus such as a standard computer system. Suitable computer systems could run an operating system such as Solaris™, Linux™, Unix™, Windows™, MSDOS™ or OS/2™ and may be based on a processing architecture such as a Sparc™ or UltraSPARC™ processor from Sun Microsystems Inc, an x86 compatible processor from Intel Corporation or AMD Inc or an Alpha processor. The computer systems can be provided with a local disk and memory. A node 3 is the lowest unit of failure in the database 1. The architecture of the present example is a so-called “shared nothing” architecture wherein neither primary memory nor disks are shared between nodes. Neither primary nor secondary memory is typically shared in a database with fault masking capabilities because memory is a critical component used by servers in all nodes. This makes it possible for a node to fail or be replaced without involving other active nodes. If one component inside a node fails, then the whole node is removed from the database and replaced.

Although the database architecture illustrated in FIG. 1 suggests that both groups 9 are in the same physical location, it is a logical architecture that is represented. The separate groups may be in different physical locations, which assists in managing network failures or disasters such as fire, flood, terrorism or sabotage. In the present example, even if the groups are present in the same physical location, each group 9 is totally independent of the other group 9 in terms of cooling and power supply. Thus a cooling mechanism failure to one group which causes all nodes in that group to overheat and power-down will leave the other group unaffected. Similarly, an interruption in power supply to one group will leave the other group unaffected.

In the present example, the database 1 appears to clients as a single database. Each node can run an outside world interface and thus a client can connect to the database via any of the nodes. Distribution of clients between nodes may be performed on a one-time only basis such that a given client always connects via a given node, or a distribution mechanism can be used to connect clients to a given node on a per session or per query basis. Each node has the same role as each other, and runs the same software. The only necessary difference between nodes is the data they store, although the nodes do not need to be identical and can have different storage capacities and/or processing capabilities. Such similarity between nodes aids scalability, promotes a parallel system and simplifies fault handling. As will be explained below, each node stores approximately the same volume of data and experiences approximately the same processing load as every other node.

Node Architecture

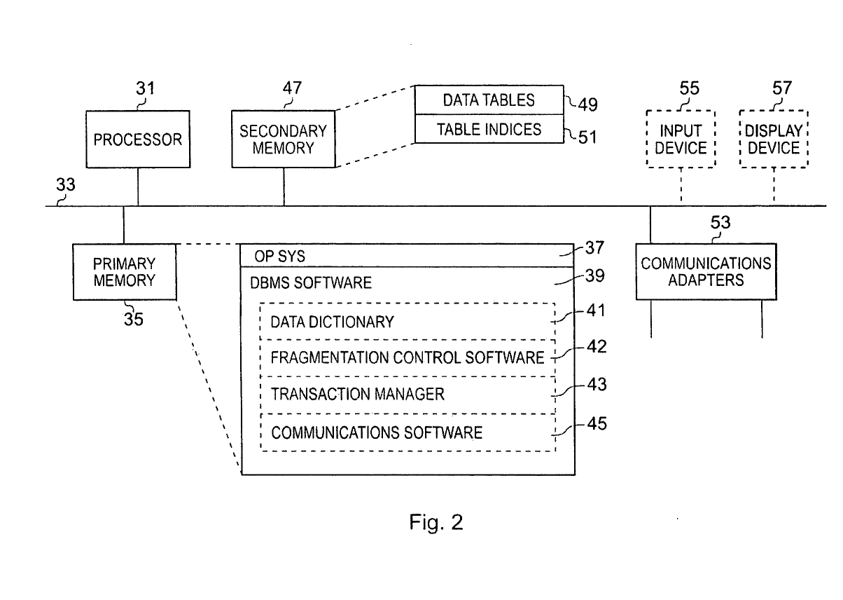

With reference to FIG. 2, an example of a computer system suitable for use as a node 3 will be described.

The computer system has a processor 31 which, as described above, can be for example a Sparc™ or UltraSPARC™ processor from Sun Microsystems Inc, an x86 compatible processor from Intel Corporation or AMD Inc or an Alpha processor. The processor 31 is connected to one or more internal communications buses 33 for communication with other components of the computer system. A primary memory 35 is provided, which can be a high speed random access memory such as SDRAM. Secondary memory 47 is also provided, which can be magnetic hard disk storage. The computer system also has communications adapters 53. The communications adapters allow the computer system to connect into the dual redundant switch fabric 5 that provides for communications between the nodes of the database 1. The computer system may be provided with interfaces to allow an input device 55 and/or a display device 57 to be attached. The presence of such devices would allow local access to the computer system, for example for carrying out system management functions. In some examples, no such devices are provided and all external communications to and from the node are made via a communications adapter which may be the adapters 53, or may be a separate communications adapter provided specifically for that purpose.

The secondary memory 47 can store the data records allocated to the computer system under the fragmentation scheme. This data typically comprises a number of data table fragments 49 and corresponding table indices 51. The secondary memory can also store programs which the computer system is to execute. Alternatively, some or all of the programs can be stored in a non-volatile memory such as a FLASH memory (not shown).

The primary memory 35 can be store currently executing programs. The programs can include the operating system 37 that the node is running, as described above, the operating system can be, for example, Solaris™, Linux™, Unix™, Windows™, MSDOS™ or OS/2™. Other currently executing programs can include database management system (DBMS) software 39, which may in turn include a data dictionary 41, fragmentation control software 42, a transaction manager 43 and communications software 45. A copy of the data dictionary 41 can also be maintained in the secondary memory 47. As will be described in more detail below, the data dictionary 41 can be used to determine the location of fragments of any given database table and the fragmentation control software 42 controls the processes of fragmenting database tables, masking node failures, making extra replicas of database fragments and reconstructing database fragments on nodes after a failure recovery.

Fragmentation

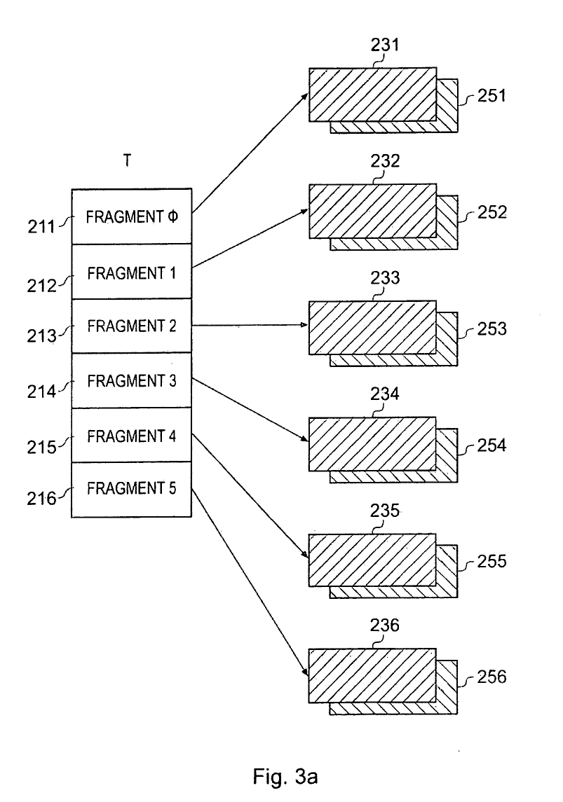

With reference to FIG. 3, there will now be described a scheme for distribution of data records about the database 1.

FIG. 3a shows an illustration of how the data in a table T is fragmented for distribution about the nodes 3. For the purposes of data distribution in the present example, the table T is divided into six fragments, Fragment0 to Fragment5 211 to 216. The number of fragments is chosen as the number of nodes in the high availability database 1 minus the number of nodes that it is desired to have as spares for increasing fault tolerance. In the present example, where eight nodes are provided, two are chosen to be used as spares, leaving six nodes for data storage. In the present implementation where two groups 9 are provided, two copies, typically described as replicas, are made of each fragment. The replicas of each fragment are named the Primary Fragment and the Hot Standby Fragment. Thus Fragment0 211 has a corresponding Primary Fragment 231 and Hot Standby Fragment 251, and so on for the other fragments 212 to 216. In other examples additional replicas may be produced for a given fragment, these replicas can be termed “additional read-only replicas” and can be made available for read operations from external entities and applications in order to provide reduced data access times for read operations. An additional read only replica can be declared hot standby in the event of the primary fragment becoming unavailable due to node failure and the original hot standby being declared primary.

Each fragment may therefore include a number of records from the table T. As will be appreciated, a given database may include many tables, each of which will be separately fragmented and distributed between the nodes. Also, in many examples the number of nodes may be much greater than the eight nodes of the present example. A database used for tracking the location of mobile telephones within a cellular telephone network may have to track millions of such telephones and the database will thus contain many tables, each having a very large number of records. In a database of the type described in the present example, a relatively high node to data volume ratio can be employed to help meet the real-time processing requirements of many database users.

The term “record” as used herein is synonymous with the term “tuple” often used in database computer science literature. A record or tuple is defined as a unit of data uniquely identified by a key value. In the present example, the splitting of data into fragments is performed using a hash function. An example of a suitable hash function for fragmentation is:
v=kmodulon
where k is based on the key value of part of a key associated with a given record, n is the total number of fragments that the table in which the given record is located is to be divided into, and v is the result which is used to select the record's fragment. v will always have a value between 0 and n−1. For example, if the key value for a record is 14 and n=6, then the record belongs in fragment 2. As new records are created in a table, they are stored in the node which stores the corresponding table fragment.

The way in which the fragments are distributed around the nodes 3 is illustrated in FIG. 3b. In the present example, the Primary and Hot Standby fragments of any given fragment are always allocated to different nodes and to nodes in different groups 9. As described above, the groups 9 of the present example are independently resourced for power and cooling. This provides a reliability benefit in that if one group fails for any reason, all of the data is still available on the other group. Thereby a single point of failure is avoided.

FIG. 3b shows a distribution scheme for distribution of the fragments between the nodes 3 of the database 1. In the present example, the Primary replica 231 of Fragment0 is allocated to Node0, and the Hot Standby replica 251 of Fragment0 is allocated to Node4. The Primary replica 232 of Fragment1 is allocated to Node1, and the Hot Standby replica 252 of Fragment1 is allocated to Node5. The Primary replica 233 of Fragment2 is allocated to Node2, and the Hot Standby replica 253 of Fragment2 is allocated to Node6. The Primary replica 234 of Fragment3 is allocated to Node4, and the Hot Standby replica 254 of Fragment3 is allocated to Node0. The Primary replica 235 of Fragment4 is allocated to Node5, and the Hot Standby replica 255 of Fragment4 is allocated to Node1. The Primary replica 236 of Fragment5 is allocated to Node6, and the Hot Standby replica 256 of Fragment5 is allocated to Node2. Node3 and Node7 are allocated as spare nodes. They thus are the same in hardware and software as the nodes with data allocated but do not have data allocated at an initial data distribution time. As will be explained below, spare nodes may be used as a result of node failure or during a software update cycle.

During normal operation of the database, when all nodes are operational, database operations are performed using the Primary replicas. The records in the Hot Standby replicas are kept up to date by sending all log records produced by transactions from the node with the Primary replica to the node with the corresponding hot standby replica. Thereby operations performed on the Primary replica can be repeated on the Hot Standby replica using the logs. A check can be performed at the Hot Standby replica to ensure that the logged operation has not already been performed at that replica, which can occur when a table has been refragmented or rebuilt.

Various data distribution schemes can be adopted in place of the hash of a key scheme described above. These can include an indirect link to a key scheme, and a key value scheme.

By distributing the data in this manner the load on the nodes is maintained substantially equal, thereby reducing a requirement for an external load balancer to distribute tasks between the nodes. Also, by maintaining a high node to data volume ratio, a high transaction throughput can be performed.

Finding Records

Location of records within the database is performed by a hashing function. In other examples, a table or index of data distribution can be used, although this itself will require to be maintained in primary and backup forms to avoid a single point of failure. The hashing function used in the present example is used to determine the fragment in which a given record is stored. This function is used each time a transaction requires access to a data record which has not already been located in the transaction in question. In the present example, the same hashing function given above can be used for finding the distributed records. A given database record can be found by applying the hash function to the record's key value k and the number of fragments n. The value v determines which fragment the record belongs to.

Normal Operation

During normal operation of the database, transactions are performed on the data in the primary replicas. The hot-standby replicas are kept up-to-date with the transactions occurring on the primaries by copying-in the hot-standbys during the transactions.

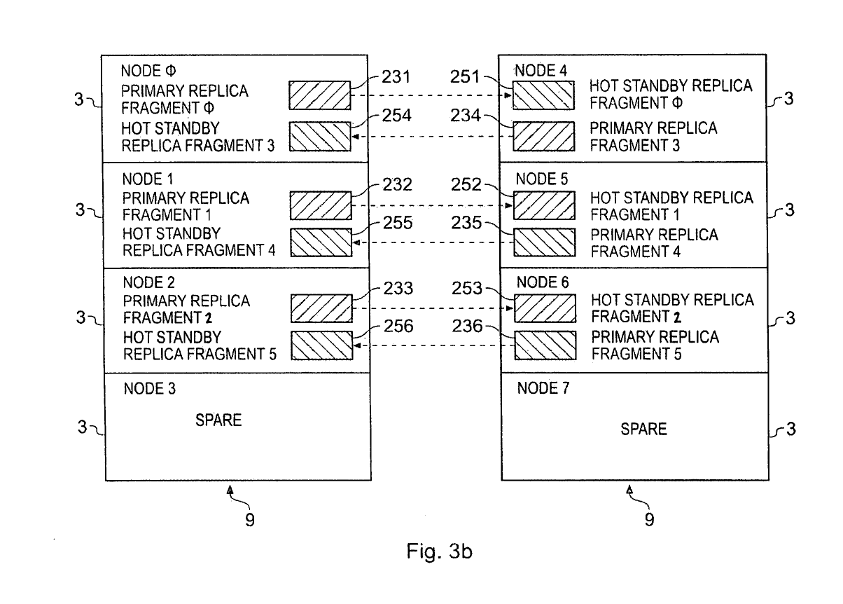

Shown in FIG. 4 is a schematic representation of database software services executed by each node. These services are parts of the database management software 39 running in main memory 35 of the node 3. The illustrated services handle client requests and manage the transactions and data. The services run by the nodes are: a Node Supervisor (NSUP) 70; a Kernel (KERN) 72; an Update Channel (UCHN) 74; and a Transaction Co-ordinator (TCOR) 76. In addition, each node runs a query processor 78.

The TCOR 76 is responsible for handling connections from database clients, and managing the transactions they require running on the database. The KERN 72 is the data manager module which stores the log records for the operations carried out as part of transactions conducted by the node and stores data in the database itself, for example in primary memory 35 and/or secondary memory 47. The transaction log may be referred to as a tuple log. The transaction log is stored in main memory 35 by the transaction manager 43 of which the KERN 76 is a part.

The UCHN 74 is responsible for reading the local transaction log and for shipping log records from primary fragment replicas, to hot stand-by replicas.

In operation, the database takes a query or request from a client and directs it to one of the nodes 3. In the described example, the client query can be in any query language recognised by the query processor 78. In one example, the well-known standard Structured Query Language (SQL) can be used. The node which receives the query can either handle the query itself or directs the query to another node according to various criteria including current load and availability. The selected node becomes the transaction co-ordinator for the present query. The transaction co-ordinator 76 need not be in the same node 3 as the host of either the primary or hot-standby replica of a record to be updated or accessed during the transaction. The client query is input to a query processor 78, which translates or converts the received query into instructions for the TCOR 76. When a TCOR 76 receives a client request from the query processor 78 on behalf of a client, it enters the transaction into a transaction table. The transaction may have already been entered into the transaction table, for example by the receiving node of the query. The transaction table has one entry for each ongoing transaction being performed under the control of the TCOR 76 at the individual node. The client request results in a sequence of instructions, some of which may be executed by the TCOR 76 and some of which are shipped to the data for execution. The database of the present example uses a so-called “two-phase commit” protocol for executing transactions. This provides a so-called “2-safe” standard of database integrity.

For more details of the principles of 2-safe and 1-safe for transaction management, see for example, “Transaction Processing: Concepts and Techniques”, J Gray & A Reuter, 1993 Morgan Kaufmann, ISBN: 1558601902 and “Two-Epoch Algorithms for Disaster Recovery”, H Garcia-Molina & C A Polyzois, Proceedings of the 16^{th} VLDB Conference 1990. Definitions for 1-safe and 2-safe are provided in Gray et al. in chapter 12.6.3 at page 651.

1-safe: In a 1-safe design, the primary transaction manager goes through the standard commit logic and declares completion when the commit record is written to local log. In a 1 safe design, throughput and response time are the same as in a single-system design. The log is asynchronously spooled to the backup system. The design risks lost transactions.

2safe: When possible, the 2safe design involves backup system in commit. If the backup system is up, it is sent the transaction log at the end of commit phase 1. The primary transaction manager will not commit until the backup responds (or is declared down). The backup TM [transaction manager] has the option of responding immediately after the log arrives or responding after the log has been forced to durable storage. The 2safe design avoids lost transactions if there is only a single failure, but it adds some delay to the transaction commit and consequently response time.

This definition for 2safe can be considered to be a complete definition since correctness criteria after a failure restart is well established. For 1safe however, further definition is required since correctness criteria after restart are lacking. To complete the 1safe definition the correctness criteria from Garcia-Molina et al. at page 224, chapter 2.2 should be added:

Correctness Criteria:

Requirement 1—Atomicity: If W(Tx,d) [write operation performed by transaction Tx on record d] appears in the backup schedule, then all Tx's write operations must appear in the backup schedule.

Requirement 2—Consistency: Consider two transactions Ti and Tj such that at the primary Ti->Tj [transaction Tj is dependent on Ti]. Transaction Tj may be installed at the backup only if Ti is also installed (local consistency: dependencies are preserved). Furthermore, if both write record d, W(Ti,d) must occur before W(Tj,d) at the backup (mutual consistency: the direction of dependencies are preserved).

Requirement 3—Minimum divergence: If a transaction is not missing at the backup and does not depend on a missing transaction, then its changes should be installed at the backup.

By provision of this, and other features of the database system of the present example (for example the shared nothing architecture) an ACID database model can be provided. ACID describes the four principal desirable properties of a reliable database: Atomicity, whereby a transaction is either done or undone completely (such that following a failure all operations and procedures should be undone and all data should roll back to its previous state); Consistency, whereby a transaction transforms a system from one consistent state to another consistent state; Isolation, whereby each transaction happens independently of other transactions occurring at the same time; and Durability, whereby completed transactions remain permanent, even during system failure.

Performing shipping of functions to individual nodes provides an environment wherein each active node can be managed to experiences substantially the same function processing load as all other active nodes. Thus, the system of the present example provides approximately equal workload to all nodes without a requirement for separate load balancing management.

In the present example, some transactions may be single action transaction, such as reading or writing from or to a single record. On the other hand, some transactions may be large transactions involving multiple actions on multiple records. In these circumstances, one node can act as a transaction manger for the overall transaction, with the same and/or other nodes acting as transaction co-ordinator for individual parts of the overall transaction. In some examples, the transaction handling method used in the database 1 can be a protocol in accordance with the X/Open standard for distributed transaction processing (The XA Standard). This standard is now administered by The Open Group (www.opengroup.org) and a full copy of the standard can be ordered therefrom.

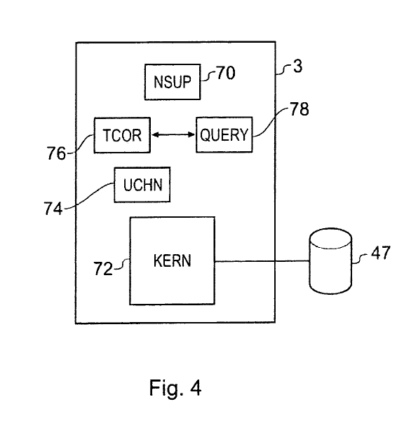

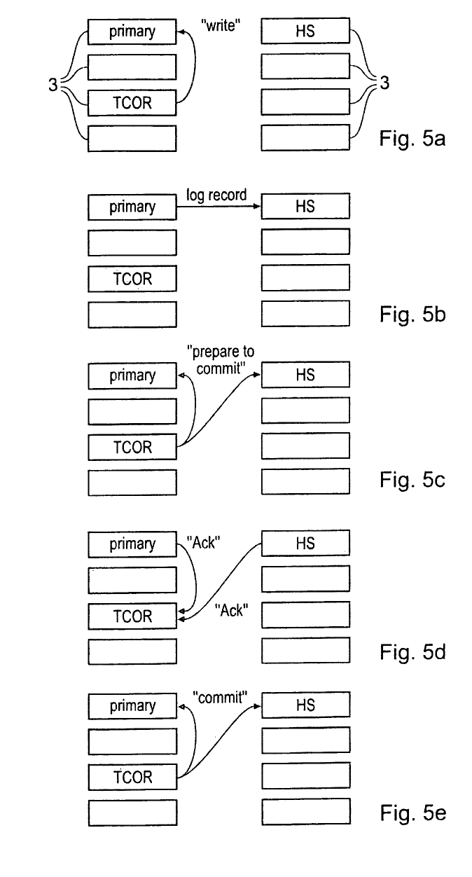

An example of a “write” transaction will now be described with reference to FIGS. 5 and 6. In this example, the Primary fragment is located in node 0, the Hot Standby fragment in node 4 and the transaction co-ordinator is node 2. These nodes will be referred to as Primary, Hot Standby and Transaction Co-ordinator respectively in the example. The start of the transaction, as shown in FIG. 5a, comprises the transaction co-ordinator sending a write command to the Primary (step S6-1). The primary then performs the write, enters a log record for the write operation into its log(step S6-3) and sends a copy of the log record to the Hot Standby as shown in FIG. 5b (step S6-5). The transaction Co-ordinator then sends a “prepare to commit” message to each of the Primary and Hot Standby as shown in FIG. 5c (step S6-6). The “prepare to commit” message can include an indication of the number of log records the hot standby should have received up to this point. In one example, the “prepare to commit” message is “piggy-backed” onto the write command top the Primary. In this example the prepare to commit message can be transmitted to the Hot Standby either as a separate “prepare to commit” message as described above, or with the log record sent to the Hot Standby from the Primary. The Primary then sends an acknowledge to the transaction co-ordinator as shown in FIG. 5d (step S6-7). The Hot Standby also sends an acknowledge to the transaction co-ordinator once it has received the indicated number of leg records for the transaction (step S6-7). The transaction co-ordinator, upon receipt of the acknowledges, informs the transaction manager (if this is part of a distributed transaction) or the client (which gave it the function to perform) that the transaction is ready for being committed (step S6-9). When the transaction co-ordinator receives the commit decision from the transaction manager or the client, the commit decision is sent to each of the Primary and Hot Standby, as shown in FIG. 5e (step S6-11). Finally, as the Primary has already performed the write, no further action is needed thereby. The Hot Standby can perform the write operation at any time after receiving the log record from the primary at step S6-5. In the present example, this is illustrated as being performed after the Hot Standby receives the commit decision (step S6-13). If the transaction co-ordinator does not receive confirmation that the transaction is to go ahead from its client (at step S6-9), then an abort instruction is transmitted to the Primary and Hot Standby by the transaction co-ordinator and the Primary undoes the write, making compensation log records. In one example, the instruction to commit can be given to the transaction co-ordinator by the transaction manager or client as part of the instruction to perform the write operation. In this example, the transaction co-ordinator can commit the transaction immediately without involving the transaction manager or the client.

In order to guard against a failure of the primary node during the transaction process, the commit decision can be logged to a hot-standby TCOR to avoid blocking in the two-phase protocol in the case where the primary TCOR is lost. In the case of a XA transaction, the prepare-to-commit decision can also be logged to the hot standby TCOR.

By means of this process, it is apparent that each of the Primary and Hot Standby nodes of any given node pair will have identical transaction log records for each transaction, at least as far as records which reflect database state changing operation are concerned. Thus the Hot Standby node provides a true mirror logging service to the Primary node. It is not necessary for the performance of the mirroring operation that the records relating to the two-phase commit are identical, and they may in many cases not be in the same order at the two nodes, or in some cases identical. Examples of log records relating to the two-phase commit are “transaction start”, “prepare to commit”, “commit”, and “abort” records.

During other database operations, the mirroring operation can be maintained by the nature of the logging used. During some operations, the log records are made by the Primary node during state changing transactions and are then shipped to the Hot Standby for processing. Based on the shipped log records, the Hot Standby is able to perform the same operations on the Hot Standby data as were performed on the Primary data. This can be considered to be “re-doing” the operation. An example of this functionality is the processing carried out by the Hot Standby in response to receiving the log record as shown and discussed with respect to FIG. 5b above.

In the present example, transaction outcomes (transaction starts, prepare to commits, commits and aborts) are handled differently to log records affecting the database state. Thus a transaction outcome log is calculated individually at each participant node. An example of this functionality is the processing carried out by the Hot Standby in response to receiving the “commit” instruction as shown and discussed with respect to FIG. 5e above. As a result of this, it is possible that the sequence of commit and abort log records may differ between the Primary and Hot Standby nodes. Thus the log records may not be identical between Primary and Hot Standby nodes even though the mirroring operation between the two nodes is being carried out.

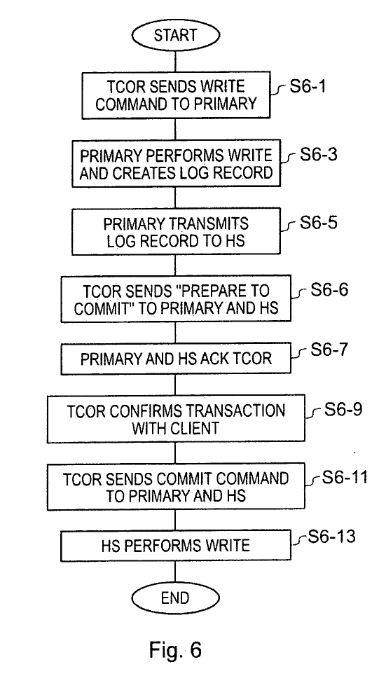

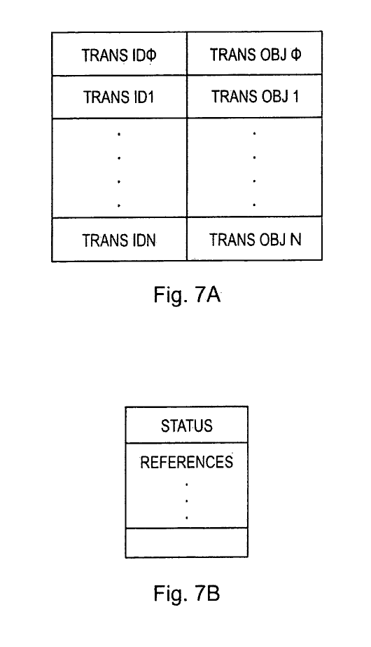

FIG. 7a shows a transaction table for recording details of ongoing transactions. A transaction identifier (TRANSID) is stored for each transaction currently ongoing. Associated with each transaction identifier is a transaction object (TRANSOBJ) which stores data describing the transaction. There are as many entries in the transaction table as there are ongoing transactions. As shown in FIG. 7b, the transaction object includes a status field describing the current status of the transaction. Possible statuses include Started and Prepared to Commit. Once a transaction is committed, it is no longer ongoing and so need not maintained in the transaction table. Accordingly, in some examples, a transaction can be deleted from the transaction table once all participant nodes have acknowledged receipt of the commit instruction.

When a KERN 72 receives a request from a TCOR 76, it executes the instructions, inserts log records into the log (if any alteration has been made to the data—a read instruction creates no log as no data is altered) and sends a reply back to the TCON 76. At the same time, the UCHN 74 scans the log and immediately ships the new log records to the hot standby replicas in the corresponding mirror node(s). The KERN 72 of the node(s) storing the hot standby replica(s) receives the log records and inserts them into the local log to form a mirror log of the transactions occurring on the primary node KERN 72. In order to ensure the updates are not lost during a node failure, the hot standby is involved in the two-phase-commit as participants (as described in the example above) and does not reply before all log records belonging to the committing transaction have been received by the mirror KERN 72. This ensures that the log records are stored on two different nodes before the transaction commits.

The KERN 72 of each node can maintain a transaction log records for all the transactions executed by that node. In the present example, the log can contain checkpoint log records made at regular time intervals. The checkpoint log records can include a list of all active transactions at the time of creation of the checkpoint. In the present example, log records are maintained in the log maintained by the KERN 72 until they are two checkpoints old. The log fully reflects client transactions and a log record will contain both before and after images, and therefore the log record can be applied to any replica of the fragment. Log records can be replicated to other nodes in the same fashion as fragment replicas.

Node Failure

In order to provide the level of availability required by many database users, it is necessary to mask node failures from the point of view of the database clients, that is both the owner of the data held in database and the customers of the owner who receive a service which is dependent upon the database being available. Node failure may be a software failure or a hardware failure. Software failure can be a so-called “crash” of one or more parts of the database software running on the node, a crash of the node operating system, or a crash of network software. Hardware failure can be a physical failure of one or more components of the node, for example the processor 31. Hardware failure can also be a power failure to the node, causing it to switch off or it could be a forced power-down of the node, for example by an environmental monitoring daemon which causes the node to power down in the event of an excess temperature. A forced power-down can also be a deliberate power-down by a management system, for example to remove a node from the database 1 for maintenance or upgrading of hardware or software.

In the present example, in order quickly to detect a node failure after it occurs, a multi-way watchdog system is used. In the present example, the watchdog monitoring is carried out by the NSUP 70 of each node. Each node sends an “I'm alive” message to at least two other nodes at a predetermined interval. In the present example, the interval can be from 100 ms to 1 s. If the nodes to which the I'm alive messages are destined do not receive those messages, a “who's alive” protocol is initiated, during which all operational nodes are identified. This fault discovery process is known as the “VP protocol”. If by performing the VP protocol it is detected that a node is no longer active, then a remedial action can be taken.

Single Node Failure

If, using the VP protocol, it is discovered that a node is no longer active, then nodes storing Hot Standby replicas of any Primary replicas stores by the failed node declare themselves Primary for those replicas. The process of becoming Primary from Hot Standby can be termed “takeover”.

During a takeover operation the new Primary node (which is up to date for completed transactions by virtue of the synchronisation of Primary and Hot Standby system) simply takes over the role of Primary node. During operation of that node as the new Primary, it is possible for any transactions which were in progress at the time of failure of the original Primary node to be cancelled. Thus the status of the fragment can be rolled back to a “last-saved” position, being the position that all completed transactions are saved and any incomplete transactions are aborted. This scheme for performing takeover provides a predictable duration for a takeover operation between node failure and new Primary being online.

One inevitable result of a node failure is that the mirroring operation between Primary and Hot Standby ceases as the failed node will not be making log entries whilst failed. Accordingly, the logs of the Primary and Hot Standby will diverge from the point of node failure, with the non-failed node making new entries and the failed node making no new entries. In the present example, the logs of the two nodes can be merged to ensure continued true mirrored logging between the nodes as part of the recovery process, so that the recovered node is up-to date at the time of being placed online as a Hot-Standby.

Recovery

Following a takeover operation, one of two possible courses of action can be followed to re-establish the redundancy of replica hosting which is removed by the failure and subsequent takeover. These two courses of action can be termed recovery (or takeback) and repair.

A recovery operation comprises using log records from the node which took over following a failure of a node to bring the failed node back up-to-date after the failed node is restarted or otherwise recovered. It is therefore helpful for the recovery process that the recovering node has all of the necessary log records to rebuild the copy at the failed (recovered) node, however this is not essential as will be described below. Once the restarted node is back up-to-date it can take back the role of primary/hot-standby on all fragments which it was primary/hot-standby for respectively prior to the failure. The exact delay between failure of the node and it becoming available again which is deemed acceptable to permit recovery can be determined by the user. However, recovery is most optimally performed when the number of transactions which the node has missed out on being a part of due to its failure is as low as possible. In many applications where large numbers of transactions occur over a short period of time, recovery may typically only be used in instances where the node failure was caused by a failure of the database software running on the node such that the restarting of the node simply comprises restarting the database software. In other situations, e.g. operating system failure or hardware failure, a repair operation may typically be used.

In order to provide for recovery of the failed node a so-called “bump-up” procedure is used by the new Primary. It is almost inevitably the case that at node failure, there will be log records of operations in the log of the failed node which are not in the log of the new primary. This is due to latency in transmission time across the network fabric 5 and in the software on the primary node which ships the log records to the Hot Standby. To allow for this gap in log records, the new Primary performs a bump up operation which causes the log to jump up a number of entry spaces to allow for the log entries which are unavailable due to the failure of the original Primary. The logs at the new Primary then continue at the new higher log address.

If a recovery operation occurs, before the original Primary takes back the role of primary from the original Hot Standby the original Primary has to bring its log back up to date using the logs of the new Primary. The way that this is performed is that the logs of the new Primary are shipped to the original primary in the order in which they occurred, starting at the first log entry made by the new Primary following failure of the original Primary. There may be a number of log entries transmitted in this way that the original Primary already has, and these will be ignored. However, when the original Primary receives the bump-up log entry, it performs a bump-up reversing process. That is the original primary stops looking at the log entries from the new Primary and performs an undo of the operation described in each of its own log entries which are not in the new Primary's log to new log locations, creating a compensation log record for each undo. These undo operations are performed, and the compensation log records created, in reverse order compared to the order in which the original operations took place. In the present example, these undo operations are logged starting at the log address half way from the address of the first log entry which was not copied to the Hot Standby before the failure and the first log entry in the bump-up sequence. Having performed the undo entries, the original Primary then takes the log entries from the new Primary and performs all of the operations described therein to bring its own replicas up to date. Once this has occurred, the original Primary is in the same state as the new Primary and can claim back its status as Primary. The original Primary thus becomes Primary again and the new Primary goes back to being Hot Standby.

Repair

If a recovery operation is not possible due to the failed node not restarting within an acceptable timescale, a repair operation may be performed. A repair operation comprises the use of a spare node to make a new copy of the failed node. The selected spare node will typically be selected from spare nodes present on the group 9 as the failed node to maintain the separation in provision of power and other facilities between the two nodes holding the primary and hot standby replicas of a given fragment. The making of the new copy comprises making a “fuzzy” copy of the node, i.e. copying the records in their present state at the time of copying. At the same time, the log records are copied and used to update the “fuzzy” copy as the copying is underway.

The time taken to perform the copying necessary for a repair operation is dependent on the amount of date held by each node. In many examples, each node holds only a relatively small amount of data (e.g. a few tens of MB), such that a repair operation can be conducted swiftly to minimise the duration of a time period where only a single node holds replicas of certain fragments. The use of small nodes allows the use of low cost computer apparatuses for nodes, with data volume capacity typically being increased by adding nodes rather than increasing the data stored by existing nodes.

Thus it can be seen that in the present example two copies of each fragment are stored within the database 1, one copy being a primary copy and the other being a hot standby copy. The two copies of each fragment are distributed to nodes having separate cooling and power supply facilities. Spare nodes are provided to take over functionality from any nodes which fail during operation.

System Upgrades

During the operation of the database, it is conceivable that it is desired to upgrade the hardware or software of the nodes in the database. For example, a new release of the database software may become available, or a latest version may be determined not to be sufficiently reliable and a roll-back to a previous version may be desired. For the hardware, a particular component of all of the nodes may require replacing with an upgraded component (for example an upgraded network interface device), alternatively, completely new nodes may be introduced to replace existing ones. As the skilled reader will appreciate, the database will fail to meet its Class 5 availability requirement if the entire database has to be stopped to perform the upgrades.

In order to provide for such upgrades without compromising the availability of the database, such upgrades can be performed one (or a small number relative to the total number) node at a time. To upgrade a node, the node itself is shut down. This creates a deliberately induced node failure. The database will detect the failure and as the node will not come back on line in a short time, most likely effect a repair, replacing the functionality of the removed node with a spare node in the manner described above.

Transaction Log on Disc

As described above, both the primary transaction log and mirror transaction log are stored in node main memory 35. In the event of a node failure, the failed nodes mirror log stored on the corresponding paired node can be used to assist in the recovery of the failed node and to establish a transaction consistent state for the high availability database. However, if both nodes of a node pair fail then both the primary and mirror transaction logs are lost, data is likely to be lost and the database enters an inconsistent state since it is not possible to determine accurately the transaction history. Accordingly, the transaction logs can alternatively or additionally be stored on local disk in order to remove such a result arising from a multiple node failure.

Thus storage of the transaction log on a non-volatile memory allows for reliable recovery from double node failure, allowing the database to exist in a transaction consistent state after recovery from such a failure. Storage of the transaction log on non-volatile memory also provides for point in time recovery. Following a node failure, or during commissioning of a new node, a backup image can be applied to the node and then entries from the saved log can be applied in order to roll the database forward to a last saved state. Additionally, in the event that a single node database were to be utilised, a failure of that single node could be recovered from by using the saved log. Complete recovery of all completed transactions can be ensured by forcing the log to disk upon completion of the commit for each transaction, so-called “write ahead logging”. If a non-forced copying of the log to disk is used, some very recent transactions could be lost during such a restore operation, although this may not be of concern in some applications.

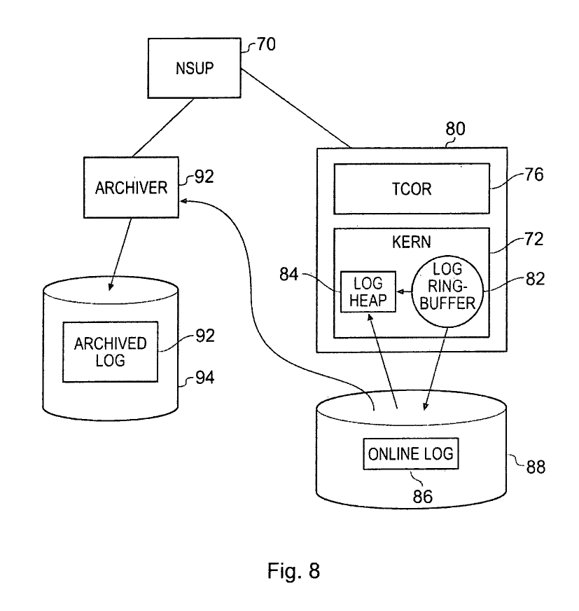

FIG. 8 schematically illustrates the logical architecture of a node configured to store the primary and mirror transaction logs on disk. A group of functions 80 is illustrated as encompassing TCOR 76 and KERN 72 to schematically represent the function shipping operation of the present example, that is that the functions TCOR 76 and KERN 72 are shipped to the data for transaction 80.

KERN 72, includes a transaction log ringbuffer 82 and a transaction log heap 84. The transaction log ringbuffer 82 buffers transaction log records until they are written to an online transaction log 86 stored on a local disk drive 88. The local hard disk drive 88 may include secondary memory 47 of the node, or may be a separate physical entity. As an alternative to a hard disk drive, a non-volatile memory such as an NVRAM or FLASH memory could be used for storage of the online transaction log 86.

In the present example, the local hard disk drive 88, on which the online transaction log 86 is stored, has a pre-allocated amount of space for storing the online transaction log 86. Thus in the present example, the online transaction log 86 is written as a ring-buffer using up all of the pre-allocated space on the local hard disk drive 88. Thus once sufficient entries have been written to the online transaction log 86 to take up all of the available space on the hard disk drive 88, old entries are overwritten by new entries. Therefore a log archiver 90 can be provided to copy the online transaction log 86 from the local hard disk drive 88 before it is overwritten. The log archiver 90 copies the log entries to an archived log 92, stored on a disk 94. The archiver 90 can be controlled by NSUP 70, KERN 72 or TCOR 76, or controlled by the high availability database administrator via a suitable tool.

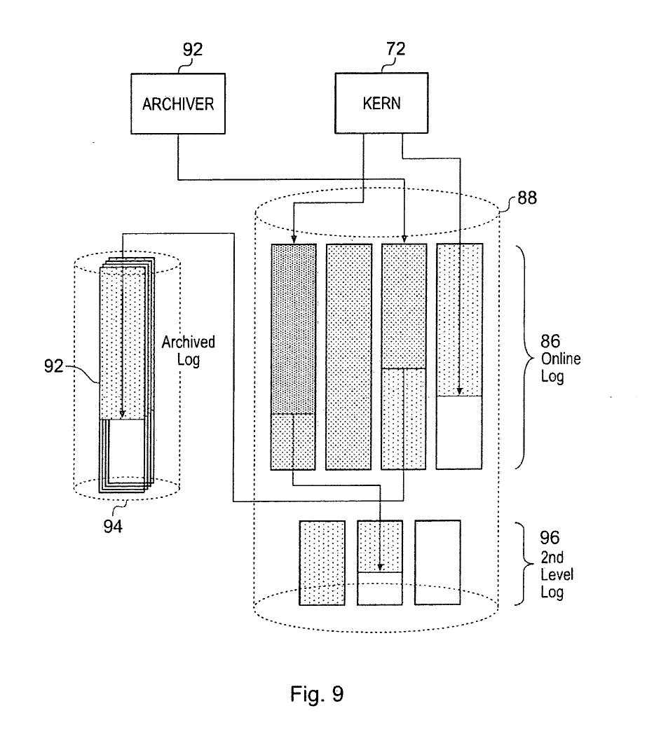

FIG. 9 schematically illustrates the logical organisation of the transaction log of the present example. The online log 86 is maintained and used by KERN 72. KERN 72 also maintains and uses a second level log 96, also stored on the local hard disk drive 88. The second level log 96 is provided to take account of transactions which take so long that the log entries for the beginning of the transaction would ordinarily be overwritten within the online log (due to the ringbuffer type nature of the online log) prior to completion of the transaction. The second level log receives copies of log entries for such transactions to provide a full log of those transactions. Movement of entries from the online log to the 2^{nd} level log is controlled from KERN 72.

Thus a full copy of all entries for all transactions can be kept to allow the rolling back of the database to a previous time position to allow for entries made erroneously to be removed and for entries made in an incorrect chronological order to be undone and remade in the correct order.

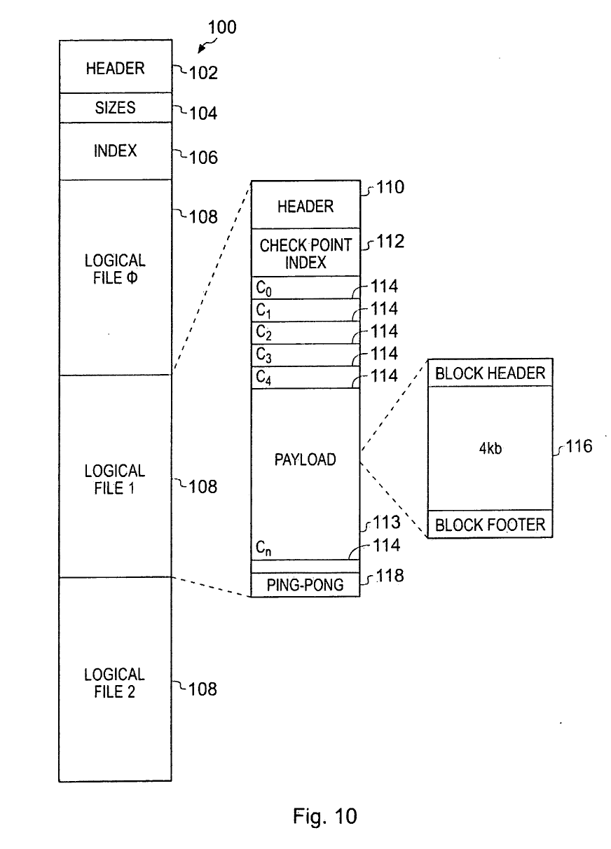

An example of the arrangement 100, of transaction log files is shown in FIG. 10. The transaction log files arrangement 100 comprises a header 102, a sizes field 104 which indicates the size of each individual log file in the overall system, and a log file index 106 which points to each separate log file 108. In the present example the log file size is typically between 2 and 50 megabytes, but other sizes can be utilised according to the demands of the system.

Each log file 108 includes a header 110, and a check point index 112 of check points 114 within the payload 113. Each checkpoint 114 corresponds to a point in time and is sometimes referred to as an “epoch” mark. Each checkpoint 114 separates a log file block 116, which comprises transaction records, for example before and after images. A typical block size for the present example is 4 kilobytes, but other block sizes may be employed. The log file 108 also has a ping-pong block 118. The ping-pong block 118 provides a mechanism to prevent data loss in the event of failed disk write transactions. If a failure occurs part-way through a write a data inconsistency can occur. To avoid data loss caused by overwriting data which needs to be kept, updates to the current block written in the online log are written to alternating positions on the disk.

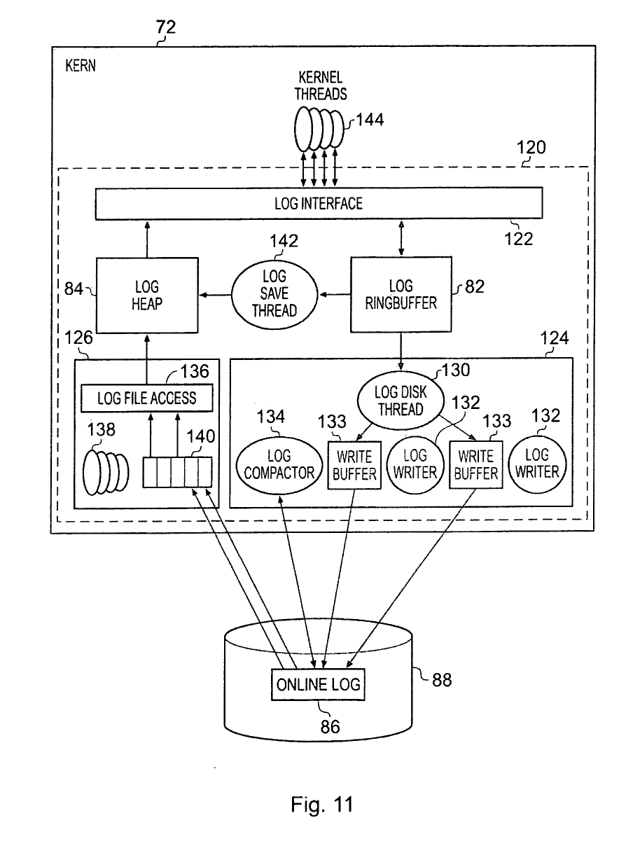

The operation of the KERN 72 for storing the log entries to disk within the present example will now be described in more detail with reference to FIG. 11. For storing and reading transaction logs to and from disk, KERN 72 uses the following main modules, which are collectively referred to herein as the log storage manager 120. These modules are: a transaction log interface 122; the log ringbuffer 82; a log diskwriter 124; the log heap 84 and a disk reader 126. The log disk writer 124 includes log disk threads 130, log disk writer threads 132 and compactor 134. The log disk reader 126 includes: log file access module 136, disk reader threads 138 and reader buffers 140. KERN 72 also uses a log save thread 142 for saving logs to the log heap 84 in node main memory.

Other kernel threads 144 which cause log entries to be made communicate with the log storage manager 120 via the log interface 122 thereof.

In use, the log storage manager 120 keeps a local log of one or more transactions performed by the data processing node in the node primary memory 35, and also stores a copy of that local log in the non-volatile memory, which in the present example is provided by local hard disk drive 88.

In some circumstances, as illustrated in FIG. 11, the log save thread 142 copies local log entries from the log ringbuffer 82 to the log heap 84, both of which are maintained in log primary memory 35. This copying is performed at intervals appropriate to ensure that no log entries made in the log ringbuffer 82 are overwritten without having first been copied to the log heap 84. In the present example, only a small fraction of records are copied to the log heap.

Additionally, the log disk thread 130 copies the log entries from the log ringbuffer 82 to writebuffers 133. From the writebuffers 133, the entries are copied by log writer threads 132 to the online log 86 stored on local hard disk drive 88. In the present example, this copying of log records to the writebuffers 133 occurs in response to the log ringbuffer 82 reaching a predefined percentage of capacity.

In one example, the log disk thread 130 operates independently (i.e. asynchronously to) of log save thread 142, in order to avoid any delay introduced by access to the hard disk drive 88 delaying the saving of log entries to the log heap 84. In this example, a transaction can commit once a log entry has been saved to the log heap 84. Tying the operation of log save thread 142 and log disk thread 130 together in this scenario could result in a delay in transactions being committed due to the length of time taken for disk access.

In another example, a transaction can commit when a log record is received by the pair node. This scenario provides good reliability in terms of fault tolerance to single node failure, but could allow some transactions to be lost if both nodes of a node pair fail during a transaction.

In other examples, the operation of these two threads is tied together (i.e. synchronous or “forced” save), thereby ensuring that the log record is saved to disk before the transaction commits. Such an arrangement ensures that should the node fail, no committed transactions are unrecoverable. In this scenario, even a failure of a node pair during a transaction will not cause transactions to be lost. Where such a forced save to the online log is not implemented, there is a possibility that a node failure could result in some log entries for committed transactions not having already been saved to disk, and therefore lost permanently from that node. As the skilled reader will appreciate, there is therefore a trade-off between extremely high reliability with reduced performance and very high reliability with greater performance in the implementation of procedure for saving log entries to disk. An example of a situation where the reduced performance but higher reliability forced save model might be implemented is the case of a single node database, where the reliability advantages of a multi-node database are not present. For a multi-node database where each node has at least one corresponding hot-standby node for each fragment which is hosted by the node, the asynchronous save model might be adopted.

The log compactor 134 operates on the entries saved to the online log 86 to reduce the disk volume used by the online log. The log compactor 134 can operate on both the main online log 86 and the 2^{nd} level log 96. For the online log 86, the log compactor 134 copies log entries from the online log 86 to the 2^{nd} level log 96 to ensure their preservation in local disk storage until the completion of the relevant transaction. Such copying therefore only takes place for long-lived transactions, as transactions of a normal length will be completed before the process of archival to the archived log 92.

For the second level log 96, the log compactor 134 tracks when files are filled and compacts them into other files. In the present example, this is performed by reading through the oldest second level log files and copying any log records belonging to still active transactions to a new second level log file. The original file than then be deleted/marked for overwriting.

The disk reader 126 can access the log entries stored in the online log for retrieval. This is typically required following a node failure where rebuilding of the database state at time of failure is to performed. The log file access layer 136 has responsibility for locating log entries in the online log and/or archived log. In the present example, log entries can be located on the basis of an identifier representing the status of the log entry (i.e. primary or hot standby) or physical save location. In order to speed up access to recently saved log entries, a cache can be kept of recently used files within the online and archived logs. The actual performance of read operations is performed by the reader threads 138, using the read buffers 140 for temporary storage of retrieved entries.

In some examples, each node of a node pair can be configured to transmit its log record to the other node of the pair. The receiving node can store the received records within either or both of the memory buffer and the hard disk or other non-volatile storage medium. Thereby a mirror of the transaction log can be held at a separate node, to provide further possibilities for data recovery and thus greater data integrity following node failure.

Log Holes

Whenever a node is active, it participates in transactions and log operations and it produces log records. When a node fails, it does not produce log records and this can lead to holes in the log at the node. As discussed above, the present example provides two methods for a failed node to resume active status: recovery and repair. These two methods have different effects on the node log.

During Node recovery, the restarted node receives from the other member of its node pair a copy of all log records produced during the restarted node's period of outage. These log records are then subjected to redo operation at the restarted node. Thus, once the recovery process is complete, the log hole at the restarted node caused by its outage is filled by the redone log records shipped from the other node of the pair and the restarted node returns to active status. Thus a log hole created by a node failure followed by recovery can be considered to be a temporary hole as the hole disappears during the recovery process.

On the other hand, if a node is returned to active status by means of node repair, then a node hole caused by the node failure is not filled by the repair process, as the repair process only ships log records created after commencement of the repair process, so that the fuzzy copy of the database fragments shipped as part of the repair process can be updated to current status by redoing the log records which occurred after the start of the repair process. Thus a log hole created by anode failure followed by repair can be considered to be a permanent hole as it is not filled by the repair operation.

During normal database operation, the presence of holes in the log at individual nodes does not cause any difficulty as the database as a whole has a complete log of all transactions spread around over the logs of the various nodes in the database.

Node Pair Failure

If two nodes forming a node pair of Primary and Hot Standby for one or more data fragments are both in a failed state simultaneously the a double node failure state, or node pair failure, occurs. If more than one Hot Standby node is provided for a data fragment, then all Hot Standbys and the Primary must be in a failed state simultaneously for a node pair failure to occur (although in such a situation more than two nodes will have failed, this situation will be referred to herein as node pair failure as the same principles apply as for the case of two nodes).

Where a node pair failure occurs there is a possibility of an inconsistent database occurring, as some log records necessary to recreate a consistent state may be missing. This can cause the ACID durability properties of the database to be lost. Recovery from a node pair failure may result in committed transactions being missed or partially executed transactions may be recorded. These difficulties can be alleviated by using the transaction log stored to disk to recover into a 1-safe consistent state when recovering from node pair failure.

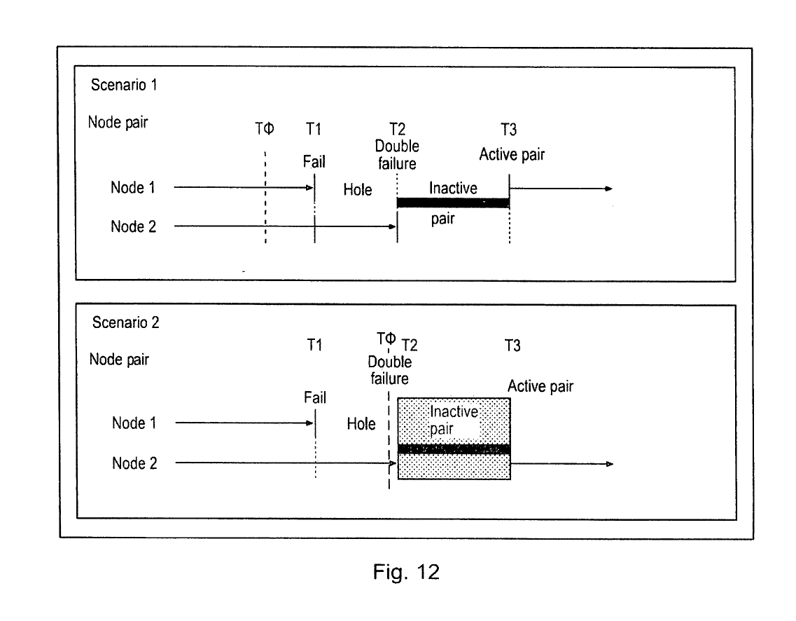

As there are several possibilities for combinations of node failures to cause a node pair failure, the possible scenarios are set out in FIG. 12.

As shown in Scenario 1, node 1 fails at time T1. While node 1 is unavailable, node 2 fails at time T2. As, in the present example, nodes 1 and 2 form a node pair (i.e., they provide hot-standby for one another). Thus a node pair failure has occurred. At time T3, node 1 becomes active again, such that the first node to fail is the first to restart. A failed node may restart with its main memory intact (e.g. if the failure was in network connection software) such that the main memory log is still present, or with its main memory wiped such that the main memory log has been lost. In both cases it is assumed that the log stored to disk is intact. These two cases can be considered as sub-scenarios 1a and 1b. Note that these two cases are only different if the database is using an asynchronous write of log records to disk. If log records are forced to disk prior to a transaction committing, then the two sub-scenarios are to all intents identical.

In sub-scenario 1a, a local restart of node 1 may lead to an inconsistent database because transactions may have been completed in the time interval between T1 and T2 when only node 2 was operational. Since the log records reflecting these transactions is unavailable when node 1 first restarts, these log records cannot be redone at node 1 following node 1 restarting. Since, in this sub-scenario, node 1 restarts with its main memory log intact, there are available all log records up to time T1 and from time T3. From this starting point, it is possible to create a consistent database by rolling back all transactions not completed at or before time T1. This may cause the ACID durability property of the database to be lost. However, a 1safe consistency property is maintained as every transaction dependent upon the database state change produced by a wiped out or lost transaction is itself wiped out. Thus, transactions may be lost, but a consistent database is maintained.

In sub-scenario 1b, a local restart of node 1 may lead to inconsistencies for the same reasons as discussed above of sub-scenario 1a. In this case, the node restarts without its main memory intact. Thus, following the restart of node 1, node 1 has available all log records up to time T0, earlier than time T1. This represents the delay between a log record being generated and that same log record being copied to the local disk. This delay may vary according to a disk log scheme applied by the node, and over time if the scheme has, for example, a buffer fill level trigger for writing log records to disk. As mentioned above, if log records are forced to disk prior to a transaction completing, then sub-scenario 1b becomes the same as sub-scenario 1a as, in this case, T0 is the same as T1. To recreate a consistent database, all transaction are rolled back to time T0. This sub-scenario therefore has the same outcome as sub-scenario 1a, but with a slightly earlier point being used to create the consistent database.

As shown in Scenario 2, node 1 fails at time T1. While node 1 is unavailable, node 2 fails at time T2. Thus a node pair failure has occurred. At time T3, node 2 becomes active again, such that the last node to fail is the first to restart. A failed node may restart with its main memory intact (e.g. if the failure was in network connection software) such that the main memory log is still present, or with its main memory wiped such that the main memory log has been lost. In both cases it is assumed that the log stored to disk is intact. These two cases can be considered as sub-scenarios 2a and 2b. Note that these two cases are only different if the database is using an asynchronous write of log records to disk. If log records are forced to disk prior to a transaction committing, then the two sub-scenarios are to all intents identical.

In sub-scenario 2a, a local restart of node 2 does not lead to an inconsistent database because no transactions can have been carried out on the fragments held by the node pair during the period of dual node failure. Since, in this sub-scenario, node 2 restarts with its main memory log intact, there are available all log records which have been created for the fragments held by the node pair. Thus the database is consistent as soon as a local node recovery has been performed at node 2. Accordingly, the ACID properties of the database are maintained.

In sub-scenario 2b, a local restart of node 2 may lead to inconsistencies as transactions may have completed during the period between the last write of log records to disk at node 2, and the failure of node 2 (time T0 to time T1) as the node restarts without its main memory intact. Thus, in order to establish a consistent database, all transactions must be rolled back to that last time that a consistent database occurred on the single node before time T0. This restart point will maintain the 1safe consistency property of the database, although the ACID durability property may be lost.

In scenarios 1 and 2 discussed above it has been assumed that, in the choice between availability and durability, availability has the highest priority, i.e., availability has precedence over durability. If it is now assumed that the priorities are reversed, it can be considered whether it would be possible to recover a database that is maintaining its ACID properties in more of the failure scenarios discussed above if higher unavailability is allowed when double node failures occur. One possible approach would be always to wait until the node that is the last to fail restarts before restarting a failed node pair. This strategy eliminates scenario 1 above, such that all double failures becomes scenario 2 cases. When this strategy is applied it would still only be possible to recover with the full ACID properties intact in the sub-scenario where the main memory log of the last failing node is intact at restart. In practice, however, it is more commonly the case that the main memory log is lost in a node failure. This strategy would require waiting until the last failed node restarts. There is no definite time frame for this restart to occur and there is no guarantee that ACID properties would be maintained in any case. Thus in the present example, the scenarios 1a, 1b, 2a and 2b described above are utilized as they provide both durability (at least 1 safe) and availability (shortest possible database unavailability) during recovery from dual node failure.

Recovery from Node Pair Failure

As discussed above, recovery from node pair failure can follow one of four scenarios. Such recovery requires the creation of a server cluster consistent transaction break point and the undoing of all operations back to this point. The failure scenarios discussed above fall in to two categories. Scenario 1 and sub-scenario 2b allow a 1 safe consistent database after restart, and sub-scenario 2a allows a 2safe (including full ACID) consistent database after restart.

Considering first, the sub-scenario 2a (2safe) situation. Sub-scenario 2a can be handled as a local node failure where the node performs recovery based on its local log. This kind of recovery produces a 2safe consistent result because both replicas of the fragments stored at the node have been unavailable since the node failed. The node's most recent log record therefore reflects the latest operation done to these fragments. Since the node's main memory log has survived the failure fully intact, the node has a complete log locally available at restart time and the node can therefore perform a local recovery based on its log. The recovery performs redo processing from the node's last checkpoint to the end of the log followed by undo processing of every active transaction in reverse log production order starting from the end of the log continuing back until the effects of all the active transactions at failure time are wiped nut. Since the active transactions at the failure time may be active at multiple nodes a site global undo may have to be performed on every transaction being rolled back in the restart process.

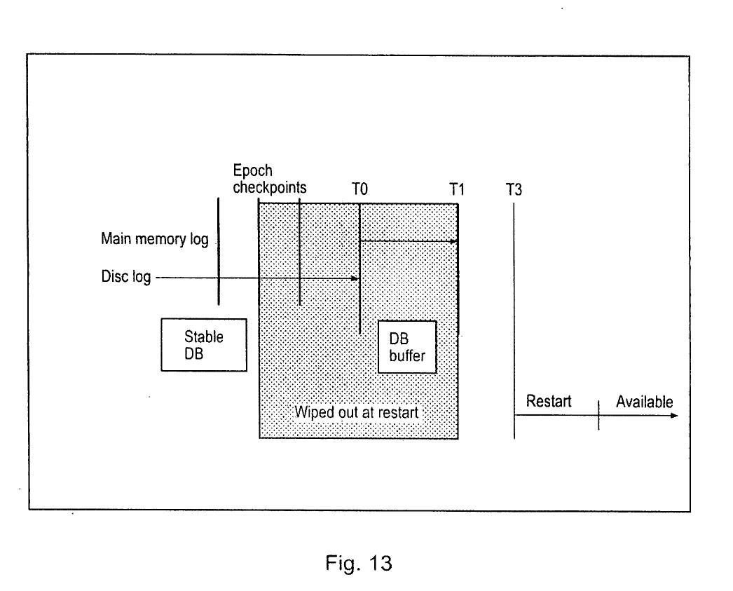

Sub-scenario 1a, sub-scenario 1b and sub-scenario 2b require the establishing of a globally consistent recovery point across all nodes to produce a site consistent recovery state. A server cluster runs the protocol to set epoch checkpoints across all available nodes within the database at regular intervals. In the present example, the epoch checkpoints can be created as special epoch checkpoints distinct from the database checkpoints. In the present example, epoch checkpoints are created more frequently than database checkpoints and the epoch checkpoints are globally created, whereas the database checkpoints are locally created. The epoch checkpoints are inserted into the log under instruction from an epoch coordinator which, in the present example, is a global entity that provides sequencing for epoch checkpoints for a whole server cluster. During a restart after a dual node failure, the set of three succeeding epoch checkpoints older than and nearest to the failure time of the recovering node are identified. Based on this set of epoch checkpoints, the transactions to keep and the transactions to roll back can be determined. The set of transactions to roll back may include committed transactions. This restart procedure creates a 1safe consistent database. An example of such a restart is shown for sub-scenario 1b in FIG. 13.

In FIG. 13 there is shown the restart timeline for node 1 in scenario 1b. As can be clearly seen in FIG. 13, the node fails at T1. As the node loses its main memory log on restarting, all of the log records between T0 (the time corresponding to the last log record written to disk at the node) and T1 are lost. Thus, upon restart of the node, the first three epoch checkpoints prior to T0 are identified. These checkpoints are then consulted to ensure that a globally consistent database will result, and all transactions after the middle epoch checkpoint are rolled back. Thus all log records from the shaded area are wiped out at restart. Once restart is complete the node, and hence the data fragments thereon, become available again.

In both of sub-scenarios 1b and 2b, the main memory log of node 1 is lost at restart. Database state changing operations that are logged only in the main memory log at the node and are reflected in the stable database at the node prior to node failure may lead to inconsistencies after a double node failure if the main memory log is lost. If the main memory log is lost and the operation is not reflected in the local disc log, the effect of the operation in the stable database cannot be undone or compensated for based on the log on disk. Since the companion node is also unavailable due to its own failure, its log is not available and can therefore not be used to avoid inconsistencies. A consistent recovery can therefore in this case not be based on the companion node's log.

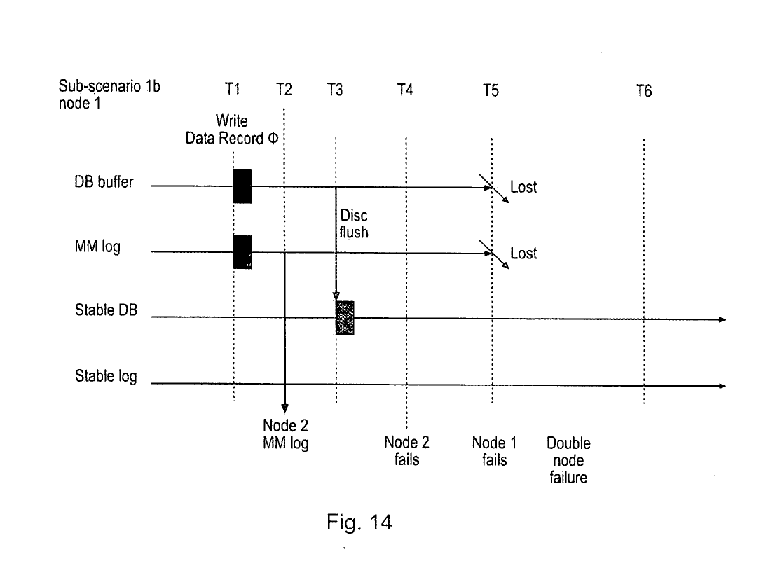

There is illustrated in FIG. 14 an example showing a possible inconsistency after a sub-scenario 1b failure. At time T1 a replica of data record 0 is written at node 1. This write-operation updates the main memory copy of data record 0 at node 1 and generates a main memory log record at the node. At time T2 the log record of the write operation is copied to node 2, resulting in a main memory copy of the log record at node 2. The neighbor log-ahead-protocol is therefore fulfilled at T2. A transaction of which the write operation is a part commits between T2 and T3. The site is now fully able to recover from any single node failure of the node pair. At time T3 the buffer replica of the block containing data record 0 at node 1 is flushed to node 1's local database disc. Node 2 then fails a time T4 causing a single failure of the node pair. The data and disc replicas on node 2 are therefore unavailable after T4. Then, at T5, node 1 fails in such a way that its database buffer (held in main memory) and main memory log contents are lost. Later on, at T6, node 1 is the first node of the pair to restart. The restart requires the transaction which includes the write to data record 0 at T1 to be undone. This is despite the fact that the write operation itself is reflected in the stable database. If, during the restart, every log record in the stable log at node 1 belonging to transactions to be undone is itself undone, the result may be an inconsistent database because operations may be reflected in the stable database but not in the stable log. These operations will not be undone under this simple approach.

As a result, a different strategy can be adopted to avoid an inconsistent database during restart after double node failure. The strategy is to avoid writing the effect of an operation to a node's stable database before the log record of the operation has been written to stable log storage at the node. This strategy uses the traditional write-ahead log (WAL) strategy locally at a node. This strategy is therefore termed the local WAL (LWAL) strategy. The application of LWAL is independent of the neighbor-WAL strategy. The neighbor-WAL strategy is applied to provide durability from single node failures. The LWAL strategy is applied to provide 1safe recovery from double node failures. If the LWAL strategy had been applied in the case illustrated in FIG. 14 above, the disc flush of the database buffer reflecting the write to data record 0 would not have been performed before the main memory version of the corresponding log record had been stored on disc. Such a force of log to disc would have avoided the resulting inconsistency illustrated in FIG. 14 because the log record on which to base an undo operation would have been available at the restart time.

In addition to the steps discussed above, the LWAL strategy can be further expanded so that double node failures combined with node disc failure can be handled. This additional level of durability provision can be effected by providing twin log disks at a node carrying out LWAL to both log discs at a node. This could be implemented as two separate disks and using separate write operations to write to each disk. Alternatively, a mirrored RAID arrangement could be used such that a single write operation is performed, and the RAID arrangement causes that single write operation to be made to multiple physical disks.

In the present example, LWAL is not linked to any transaction commits. A transaction may commit without any of its log records being stored on disc. This is in contrast to the neighbor-WAL strategy of the present example, where the logging is linked to transaction commits such that a transaction is not allowed to commit before its log records are reflected in the main memory of two nodes. The LWAL and the neighbor WAL strategies are therefore independent of one another in the present example. Therefore, in the present example, addition of the LWAL strategy to nodes to provide resilience to dual node failure, the transaction response time during normal operation will not be reduced by waiting for disk access.

Thus there has now been described a set of examples for recovering from dual node failure using the disc-based log at a filed node to effect that recovery.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

What is claimed is:

1. A high availability database having a plurality of interconnected nodes, each node having a processing engine, volatile memory and non-volatile memory, the database being configured:
at a participant node of a transaction performed within the database, to create a log record for (at least part of) the transaction;
to record a “current status” of the transaction by storing the log record in volatile memory; and
to record a long term log record of the transaction by storing the log record in non-volatile memory.

2. The database of claim 1, further configured to overwrite the log record stored in volatile memory following completion of the transaction.

3. The database of claim 1, further configured to overwrite the log record stored in volatile memory following the expiry of a predetermined time period.

4. The database of claim 1, wherein the volatile memory is a primary working memory and/or a hard disk drive of the node.

5. The database of claim 1, further configured to migrate the log record stored in non-volatile memory from a first non-volatile memory to a second non-volatile memory following the expiry of a predetermined time period.

6. The database of claim 5, wherein the first non-volatile memory is a hard disk drive of the node, and the second non-volatile memory is an archive storage device selected from a hard disk drive, a magnetic tape drive, an optical tape drive, a hierarchical storage management system, and a network attached storage system.

7. The database of claim 5, further configured to migrate the log record stored in non-volatile memory to a third non-volatile memory in addition to the second non-volatile memory if a transaction to which the log record relates is not completed before the expiry of the predetermined time period.

8. The database of claim 7, wherein the first non-volatile memory is a hard disk drive of the node, the second non-volatile memory is an archive storage device selected from a hard disk drive, a magnetic tape drive, an optical tape drive, a hierarchical storage management system, and a network attached storage system, and the third non-volatile memory is a hard disk drive of the node.

9. The database of claim 1, further configured to store the log record to volatile memory independently of storing the log record to non-volatile memory.

10. The database of claim 1, further configured to store the log record to non-volatile memory independently of a transaction completion phase of the transaction to which the log record relates.

11. The database of claim 1, further configured to store the log record to non-volatile memory in response to fill level of a log buffer of the node and/or following the expiry of a predetermined time limit.

12. The database of claim 1, wherein each node is configured into a paired node arrangement with a second node of the database in respect of each data element stored at the node.

13. The database of claim 12, wherein each node of a node pair is configured to receive a log record from the other node of the node pair and to store the received log record in at least one of said volatile memory and said non-volatile memory as a mirror log for the other node.

14. A method of operating a high availability database having a plurality of interconnected nodes, each node having a processing engine, volatile memory and non-volatile memory, the method comprising:
creating at a participant node of a transaction performed within the database, a log record of the transaction;
storing the log record in volatile memory for recording a current status of the transaction; and
storing the log record in non-volatile memory for recording a long term record of the transaction.

15. A log storage manager for a data processing node of a data processing node pair of a High Availability Database, the log storage manager operable to:
create, at a the node, a log record of a transaction for which the node is a participant node;
store the log record in volatile memory to record a current status of the transaction; and
store the log record in non-volatile memory to record a long term record of the transaction.

16. A data processing node for a High Availability Database, the node comprising:
a log save manager operable to cause a local log of one or more transactions performed by said data processing node to be stored in a main memory of said data processing node; and
a log disk manager operable to cause a copy of said local log to be stored in persistent data storage.

17. The node of claim 16, wherein the node is a node of a data processing node pair for a high availability database, and wherein the node is further operable to:
receive a log from the other node of said data node processing node pair;
store said log in said node memory to form a mirror log for said other data processing node; and
store a copy of said mirror log in said persistent data storage.

18. The node of claim 17, further operable to store said mirror log in said node memory and said copy of said mirror log in said persistent data storage concurrently with storing said local log in said node memory and storing said copy of said local log in said persistent data storage.
